(19) United States
(12) Patent Application Publication
(10) Pub. No.: US 2026/0330551 A1
(43) Pub. Date: Oct. 22, 2026

(54) HARDWARE-ATTESTED MULTI-EXCHANGE CONSOLIDATED PREDICTION MARKET PLATFORM

(71) Applicant: George William Bickerstaff, III, Greenwich, CT (US)

(72) Inventor: George William Bickerstaff, III, Greenwich, CT (US)

(21) Appl. No.: 19/713,858

(22) Filed: Jun. 19, 2026

(51) Int. Cl. G06Q 40/04; H04L 9/00

(52) U.S. Cl. CPC G06Q 40/046; H04L 9/50; G06Q 2220/00

(57) ABSTRACT

A hardware-attested platform consolidates regulated prediction market activity across two or more exchanges within a trusted execution environment. The platform ingests per-venue federated stack orchestrator master attestation quotes, validates each against its hardware-vendor attestation service, and binds them into a composite attestation chain. A cross-exchange linkage engine relates participants across venues, a probability fusion module computes fused estimates for cross-listed contracts, and a cross-exchange consistency engine enforces a committed constraint rule set sealed to the hardware, including cross-venue insider-risk propagation, Oracle resolution agreement, fused-input equality, and aggregate position limits. The platform emits a platform-level master attestation quote binding the chain, consistency result, linkage-graph commitment, fused-probability record, and consolidated output, independently verifiable by a regulator or institutional counterparty against the platform and each participating exchange without reliance on any exchange operator.

### CROSS-REFERENCE TO RELATED APPLICATIONS

This application claims the benefit of U.S. Provisional Application No. 64/046,116, filed Apr. 22, 2026, the entire contents of which are incorporated herein by reference. This application is related to commonly-owned co-pending applications directed to companion systems including a resolution-outcome oracle, a hardware-attested trade integrity system (HATIS), a verified prediction confidence scoring engine (VPCS), a regulatory-compliant wrapper system (RCW), and a federated stack orchestrator (FSO), the contents of which are incorporated herein by reference to the extent consistent herewith.

### FIELD OF THE INVENTION

The present invention relates to regulated financial market infrastructure, and more particularly to a hardware-attested platform that consolidates the attested outputs of a plurality of single-venue federated stack orchestrators across two or more regulated prediction market exchanges, computing a cross-exchange linkage graph and fused probability estimates and enforcing cross-exchange consistency within a hardware trusted execution environment to produce a single, independently verifiable platform-level attestation over the multi-exchange execution.

### BACKGROUND OF THE INVENTION

Prediction market exchanges have transitioned rapidly into regulated financial infrastructure, and regulated status imposes comprehensive compliance obligations across trade integrity, reporting, capital treatment, and market surveillance. Individual venues may employ hardware-attested surveillance and orchestration at the single-venue level. However, market participants and supervisors increasingly transact and oversee activity across multiple venues simultaneously.

The absence of multi-exchange consolidation creates a specific technical problem that does not arise within any single venue: a participant's activity, risk, and positions may be distributed across independently operated exchanges, such that insider risk, coordinated manipulation, position concentration, and resolution inconsistencies become visible only when the per-venue attested outputs are consolidated and checked against one another. No single exchange operator possesses, or can be trusted by counterparties to possess, the cross-venue view; and a software-only consolidator affords a relying party no cryptographic means of confirming that consolidation was performed correctly, on unaltered per-venue inputs, by unmodified code.

A clear need exists for a platform that ingests the hardware-attested master outputs of multiple single-venue orchestrators, computes cross-exchange relationships and fused estimates, enforces cross-exchange consistency within a hardware-protected enclave, and emits a single platform-level attestation that a regulator or institutional counterparty can verify independently—both against the platform's own hardware-vendor attestation service and, through a composite attestation chain, against the hardware-vendor attestation service of each participating exchange—without relying on any exchange operator. The present invention addresses this need.

### SUMMARY OF THE INVENTION

The invention is directed to a hardware-attested multi-exchange consolidated platform comprising a consolidation engine, a plurality of attested intake interfaces, a multi-exchange federation module, a cross-exchange linkage engine, a probability fusion module, a cross-exchange consistency engine, and a master consolidation attestation module, each executing within a hardware trusted execution environment (TEE).

In one aspect, the platform ingests per-venue Federated Stack Orchestrator (FSO) master attestation quotes from two or more regulated prediction market exchanges; validates each against the corresponding per-venue hardware-vendor attestation service; computes a cross-exchange linkage graph over participants and fused probability estimates for cross-listed contracts; performs real-time cross-exchange consistency verification against a committed constraint rule set sealed to the hardware identity of the TEE; binds the validated quotes into a composite attestation chain; and produces a platform-level master hardware-attestation quote binding the chain, the consistency-result record, the linkage-graph commitment, the fused probability record, the committed rule-set version, and a consolidated output record to the hardware measurement register.

The platform operates as the apex consolidation layer over a plurality of single-venue FSO instances, each of which itself orchestrates Oracle Resolution, HATIS, VPCS, and RCW companion applications at its respective exchange. The platform does not perform, and does not claim, the single-venue orchestration performed by any per-venue FSO instance; its distinguishing functions are multi-venue federation of FSO instances, cross-exchange linkage-graph analysis, and probability fusion, none of which is performed by any single participating exchange.

### BRIEF DESCRIPTION OF THE DRAWINGS

FIG. 1 depicts the multi-exchange consolidated platform architecture and its trust model, in subfigures FIG. 1A through FIG. 1E.

FIG. 2 depicts the end-to-end multi-exchange consolidation sequence, in subfigures FIG. 2A through FIG. 2E.

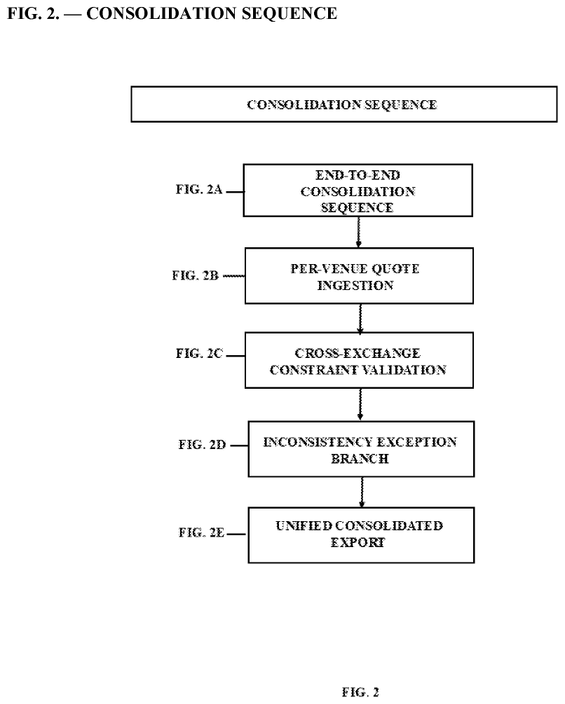

FIG. 3 depicts the multi-exchange composite attestation chain structure, in subfigures FIG. 3A through FIG. 3E.

FIG. 4 depicts the cross-exchange consistency engine, in subfigures FIG. 4A through FIG. 4E.

FIG. 5 depicts the institutional output layer, in subfigures FIG. 5A through FIG. 5E.

### DETAILED DESCRIPTION OF PREFERRED EMBODIMENTS

### Definitions

As used herein, the following terms have the meanings set forth below. The definitions are inclusive and non-limiting; each term includes, but is not limited to, the described subject matter.

“Composite Attestation Chain” means an ordered or tree-structured cryptographic record linking together the validated per-venue attestation quotes together with per-venue rule-set version commitments and timestamps, including but not limited to a linear hash chain or a Merkle-tree structure whose root serves as the multi-exchange composite commitment.

“Consolidated Output Record” means a record produced by the platform representing the consolidated multi-exchange result, including but not limited to fused probability estimates, cross-venue position aggregates, and consistency outcomes bound into the platform-level master hardware-attestation quote.

“Cross-Exchange Constraint Rule Set” means a committed set of deterministic predicates, sealed to the hardware identity of the hardware trusted execution environment, evaluated over the attested outputs of per-venue companion systems operating on different exchanges, including but not limited to insider-risk propagation, Oracle resolution agreement, fused-input equality, and aggregate position limits.

“Cross-Exchange Linkage Graph” means a graph computed within the hardware trusted execution environment relating participants observed at two or more exchanges under committed linkage rules, including but not limited to graphs over cryptographically committed participant identity representations.

“Fused Probability Estimate” means a probability estimate for a cross-listed event contract computed from per-venue verified-prediction-confidence-scoring outputs under a committed fusion rule with committed uncertainty parameters, including but not limited to inverse-variance-weighted combinations weighted by per-venue calibration credibility.

“Hardware Measurement Register” means a hardware-protected register whose contents cryptographically bind to a measured code base upon instantiation, including but not limited to platform configuration registers and equivalent measurement facilities.

“Hardware-Rooted Attestation Key” means a cryptographic key provisioned by a hardware vendor and used to sign attestation quotes verifiable against a hardware-vendor attestation service, including but not limited to keys underlying Intel, AMD, ARM, or IBM attestation infrastructures.

“Per-Venue FSO Master Attestation Quote” means a hardware-attestation quote produced by a single-venue Federated Stack Orchestrator attesting an orchestration over Oracle Resolution, HATIS, VPCS, and RCW companion applications at one exchange, chained to that exchange's hardware-vendor attestation service.

“Platform-Level Master Hardware-Attestation Quote” means a hardware-attestation quote produced by the platform and cryptographically signed by the hardware-rooted attestation key, binding the composite attestation chain, the consistency-result record, the linkage-graph commitment, the fused probability record, the committed rule-set version, and the consolidated output record to the hardware measurement register.

“Probability Fusion” means computation by the platform, and not by any single participating exchange, of fused probability estimates for cross-listed event contracts from per-venue verified-prediction-confidence-scoring outputs, including but not limited to inverse-variance-weighted fusion with committed uncertainty parameters.

“Regulated Prediction Market Exchange” means an exchange offering prediction market or event contracts under a regulatory designation, including but not limited to a Designated Contract Market under the Commodity Exchange Act, a securities exchange under the Securities Exchange Act of 1934, or an equivalent foreign regulatory designation.

“Trusted Execution Environment (TEE)” means a hardware-protected execution environment providing measurement, isolation, and remote attestation, including but not limited to Intel SGX, Intel TDX, AMD SEV-SNP, ARM CCA, and IBM Secure Execution.

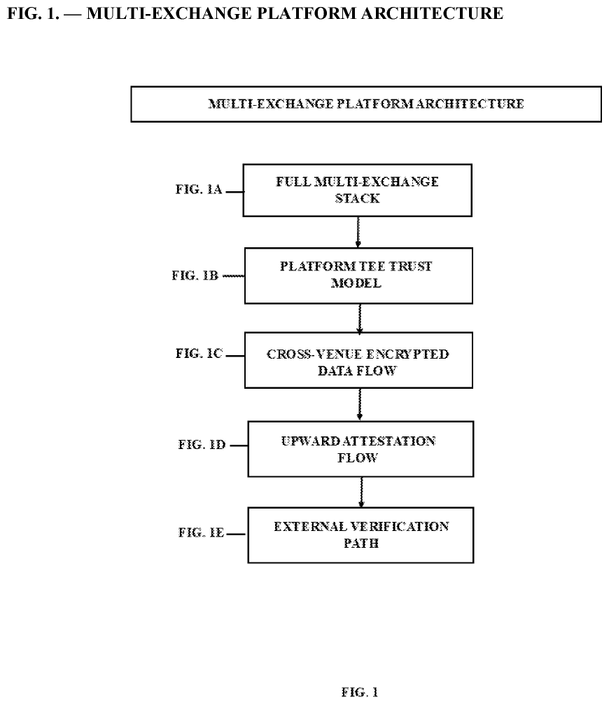

I. Platform Architecture Overview. FIG. 1 depicts a hardware-attested multi-exchange consolidated platform organized around a consolidation engine executing within a hardware trusted execution environment, surrounded by a plurality of per-venue FSO instances each orchestrating per-venue Oracle Resolution, HATIS, VPCS, and RCW companion applications. The platform produces outputs to a regulatory reporting endpoint, an institutional supervisor or counterparty, and an immutable append-only master ledger. The platform's hardware measurement register, hardware-rooted attestation key, and sealed cross-exchange constraint rule set, together with the hardware-vendor attestation services of the platform and of each per-venue FSO, constitute the trust model depicted in FIG. 1B.

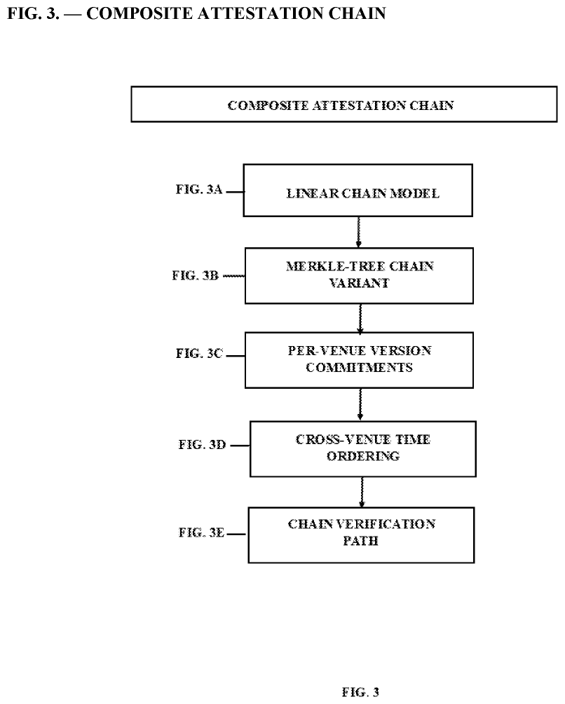

II. Multi-Exchange Federation Module. The multi-exchange federation module, executing within the hardware trusted execution environment, ingests per-venue FSO master attestation quotes over encrypted channels terminating at endpoints within the enclave (FIG. 1C), cryptographically validates each quote against the corresponding per-venue hardware-vendor attestation service, and binds the validated quotes into a composite attestation chain together with per-venue rule-set version commitments and timestamps (FIG. 3A-3D). No per-venue attested output record is eligible for inclusion in the composite attestation chain unless all applicable cross-exchange dependency constraints are satisfied.

III. Cross-Exchange Linkage Engine. The cross-exchange linkage engine computes a cross-exchange linkage graph over participants observed at two or more exchanges under committed linkage rules, resolving participant identities across venues from cryptographically committed identity representations without exposing plaintext identities outside the enclave, and produces a linkage-graph commitment bound into the platform-level master hardware-attestation quote.

IV. Probability Fusion Module. The probability fusion module computes fused probability estimates for cross-listed event contracts from per-venue VPCS-attested probability outputs under a committed fusion rule with committed uncertainty parameters, in preferred embodiments as an inverse-variance-weighted combination weighting each per-venue output by a credibility weight reflecting that venue's historical calibration performance. Probability fusion is performed by the platform and not by any single participating exchange.

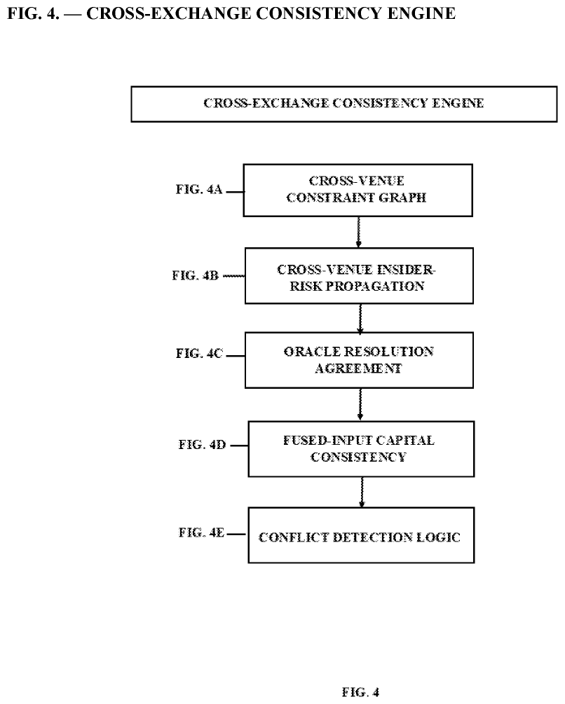

V. Cross-Exchange Consistency Engine. The cross-exchange consistency engine performs real-time verification against a committed cross-exchange constraint rule set sealed to the hardware identity of the enclave, enforcing at least: cross-venue propagation, through the linkage graph, of insider-risk indicators (computed by a companion VPCS from trade-integrity signals generated by a companion HATIS, consistent with the companion-system architecture in which HATIS detects and VPCS scores); cross-venue Oracle resolution agreement within committed tolerances; equality of fused probability inputs across an RCW capital mapping and a composite reporting transformation; and monitoring of aggregate cross-venue positions against committed limits (FIG. 4A-4E). Upon any violation, the engine produces an attested cross-venue inconsistency record identifying the violated constraint, the exchanges and participants involved, the attested values in dispute, and the committed rule-set version.

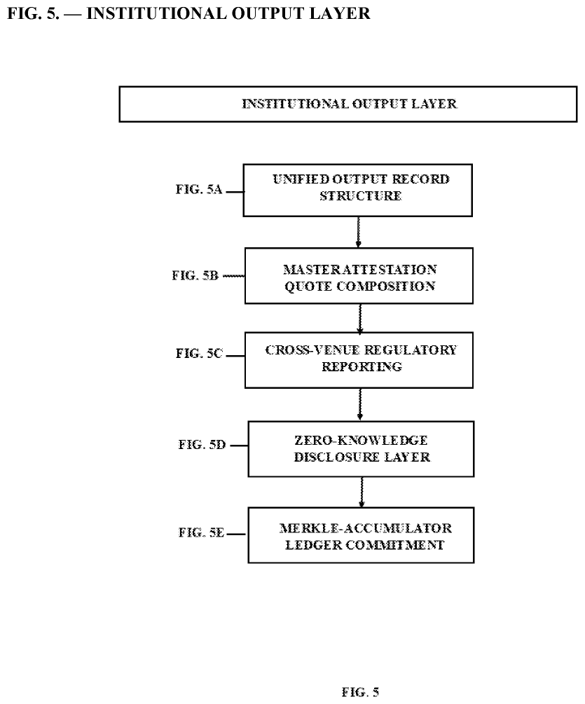

VI. Master Consolidation Attestation Module. The master consolidation attestation module produces a platform-level master hardware-attestation quote cryptographically signed by the hardware-rooted attestation key and binding the composite attestation chain, the consistency-result record, the linkage-graph commitment, the fused probability record, the committed constraint rule-set version, and the consolidated output record to the hardware measurement register (FIG. 5A-5B). The platform-level master quote is independently verifiable by a regulator or institutional counterparty against the platform's hardware-vendor attestation service and, through the composite attestation chain, against each participating exchange's hardware-vendor attestation service, without participation of, or reliance on representations by, any exchange operator (FIG. 1E, FIG. 3E).

VII. Unified Export, Ledger, and Privacy Layers. A unified multi-exchange export module produces composite cross-venue regulatory reporting records drawing upon the attested outputs of the participating exchanges, each accompanied by a hardware-attestation quote binding the report to the platform-level master quote (FIG. 5C). A tamper-evident master ledger organized as a Merkle accumulator maintains an append-only record of platform-level master quotes, with its root periodically published to an external public commitment channel, enabling relying parties to verify the temporal integrity of past platform-level master quotes through Merkle inclusion proofs (FIG. 5E). Optional differential-privacy and zero-knowledge layers (FIG. 5D) support privacy-preserving disclosure.

### ENABLEMENT EXAMPLES

Example 1 (two-venue Intel TDX consolidation). Consider a multi-exchange consolidation in which the platform, executing within an Intel TDX trust domain, ingests per-venue FSO master attestation quotes from two regulated exchanges, Exchange_A and Exchange_B, each FSO quote attesting orchestration over Oracle/HATIS/VPCS/RCW at its venue. The platform validates Exchange_A's quote against Intel's attestation service and Exchange_B's quote against Intel's attestation service, binds both into a composite Merkle attestation chain, computes a cross-exchange linkage graph identifying participant P-77 as active at both venues, and fuses the per-venue VPCS probability outputs for cross-listed contract C-001 (Exchange_A: 0.58, variance 0.010; Exchange_B: 0.62, variance 0.020) into an inverse-variance-weighted fused estimate of approximately 0.593. The consistency engine propagates a VPCS-computed insider-risk indicator for P-77 from Exchange_A across the linkage graph to downweight P-77's contribution at Exchange_B, verifies that the Oracle resolution timestamps for C-001 agree within the committed tolerance, and confirms equality of the fused input consumed by Exchange_A's and Exchange_B's RCW capital mappings. All constraints satisfied, the platform emits a platform-level master attestation quote binding the chain, the consistency result, the linkage-graph commitment, and the fused-probability record. A prudential regulator verifies the platform quote against Intel's attestation service and, through the composite chain, the two per-venue FSO quotes —confirming the consolidated result without reliance on either exchange operator.

Example 2 (three-venue multi-vendor federation with detected cross-venue inconsistency). Consider a three-venue federation in which Exchange_A operates on Intel TDX, Exchange_B on AMD SEV-SNP, and Exchange_C on ARM CCA, and the platform applies a multi-vendor attestation federation policy provisioned at enclave initialization. The platform validates each per-venue FSO master quote against its respective hardware-vendor attestation service under the federation policy. The cross-exchange consistency engine detects that participant P-23, linked across Exchange_B and Exchange_C, is classified eligible at Exchange_B but ineligible at Exchange_C absent any committed jurisdictional-variation rule —a cross-venue jurisdictional inconsistency invisible to any single venue. The engine produces an attested cross-venue inconsistency record identifying the violated constraint, the two exchanges, participant P-23, and the committed rule-set version, and the platform exports this record as a first-class verifiable regulatory output alongside a degraded platform-level master quote. An institutional supervisor integrates the consolidated output and the inconsistency record into its prudential supervisory workflow, relying on the independently verifiable platform-level master quote without instantiating a trusted execution environment of its own.

VIII. Alternative Embodiments. The platform may be practiced on any computer hardware providing the trusted-execution-environment properties described herein, and supports additional and successor TEE implementations and multi-vendor attestation federation. The cross-exchange constraint rule set is illustrative and non-limiting; additional embodiments enforce further deterministic cross-venue predicates. In fallback embodiments the platform operates without a cross-exchange linkage graph, propagating insider-risk indicators by committed participant-identifier matching rather than graph linkage. The disclosure herein supports, and the applicant reserves the right to pursue in one or more continuation or divisional applications, claims of broader or differing scope, including without limitation claims directed to cross-exchange consolidation of regulated electronic markets generally and claims directed to the probability fusion and cross-exchange linkage mechanisms independent of the prediction-market context. The foregoing embodiments are illustrative and non-limiting.

What is claimed is:

1. A hardware-attested multi-exchange consolidated platform for regulated prediction markets, comprising: at least one consolidation engine configured to execute within a hardware trusted execution environment having a hardware measurement register and a hardware-rooted attestation key provisioned by a hardware vendor, the hardware trusted execution environment configured to load a measured consolidation code base such that the contents of the hardware measurement register cryptographically bind to the loaded code base upon instantiation; a plurality of attested intake interfaces configured to ingest into the hardware trusted execution environment, over encrypted channels terminating at endpoints within the hardware trusted execution environment, per-venue Federated Stack Orchestrator (FSO) master attestation quotes from two or more regulated prediction market exchanges, each per-venue FSO master attestation quote attesting an orchestration over Oracle Resolution, HATIS, VPCS, and RCW companion applications at its respective exchange; a multi-exchange federation module executing within the hardware trusted execution environment and configured to cryptographically validate each per-venue FSO master attestation quote against the corresponding per-venue hardware-vendor attestation service and to bind the validated attestation quotes into a composite attestation chain together with per-venue rule-set version commitments and timestamps; a cross-exchange linkage engine executing within the hardware trusted execution environment and configured to compute a cross-exchange linkage graph over participants observed at two or more of the exchanges under committed linkage rules; a probability fusion module executing within the hardware trusted execution environment and configured to compute fused probability estimates for cross-listed event contracts from per-venue VPCS-attested probability outputs under a committed fusion rule with committed uncertainty parameters; a cross-exchange consistency engine executing within the hardware trusted execution environment and configured to perform real-time cross-exchange consistency verification against a committed cross-exchange constraint rule set sealed to the hardware identity of the hardware trusted execution environment, said verification enforcing at least cross-venue propagation, through the cross-exchange linkage graph, of insider-risk indicators computed by a companion verified prediction confidence scoring system from trade-integrity signals generated by a companion trade integrity system, cross-venue Oracle resolution agreement within committed tolerances, equality of fused probability inputs across an RCW capital mapping and a composite reporting transformation, and monitoring of aggregate cross-venue positions against committed limits, and to produce an attested cross-venue consistency-result record; and a master consolidation attestation module configured to produce a platform-level master hardware-attestation quote cryptographically signed by the hardware-rooted attestation key and binding the composite attestation chain, the cross-exchange consistency-result record, a commitment to the cross-exchange linkage graph, the fused probability record, the committed cross-exchange constraint rule-set version, and a consolidated output record to the hardware measurement register, wherein no per-venue attested output record is eligible for inclusion in the composite attestation chain unless all cross-exchange dependency constraints applicable to that output record are satisfied, and wherein the platform-level master hardware-attestation quote is independently verifiable by a regulator or institutional counterparty against hardware-vendor attestation services of the platform and each participating exchange without participation of, or reliance on representations by, any exchange operator.

2. A method of multi-exchange consolidation for regulated prediction markets, the method comprising: loading a measured consolidation code base into a hardware trusted execution environment having a hardware measurement register and a hardware-rooted attestation key; ingesting, over encrypted channels terminating at endpoints within the hardware trusted execution environment, per-venue Federated Stack Orchestrator (FSO) master attestation quotes from two or more regulated prediction market exchanges; cryptographically validating each per-venue FSO master attestation quote against the corresponding per-venue hardware-vendor attestation service; computing, within the hardware trusted execution environment, a cross-exchange linkage graph over participants under committed linkage rules; computing, within the hardware trusted execution environment, fused probability estimates for cross-listed event contracts from per-venue VPCS-attested probability outputs under a committed fusion rule with committed uncertainty parameters; performing real-time cross-exchange consistency verification against a committed cross-exchange constraint rule set sealed to the hardware identity of the hardware trusted execution environment, said verification enforcing at least cross-venue insider-risk propagation through the cross-exchange linkage graph, cross-venue Oracle resolution agreement within committed tolerances, equality of fused probability inputs across RCW capital mapping and composite reporting, and monitoring of aggregate cross-venue positions against committed limits; cryptographically linking the validated attestation quotes into a composite attestation chain together with per-venue rule-set version commitments and timestamps; producing a platform-level master hardware-attestation quote cryptographically signed by the hardware-rooted attestation key and binding the composite attestation chain, the cross-exchange consistency-result record, the cross-exchange linkage graph commitment, the fused probability record, the committed cross-exchange constraint rule-set version, and a consolidated output record to the hardware measurement register; and exporting the consolidated output record, the platform-level master hardware-attestation quote, and, upon identification of one or more violations, an attested cross-venue inconsistency record, in a form independently verifiable by a regulator or institutional counterparty against hardware-vendor attestation services of the platform and each participating exchange without reliance on any exchange operator.

3. A non-transitory computer-readable medium storing program instructions that, when executed within a hardware trusted execution environment of a computer system having a hardware measurement register and a hardware-rooted attestation key, cause the hardware trusted execution environment to perform operations comprising: loading a measured consolidation code base such that the contents of the hardware measurement register cryptographically bind to the loaded code base upon instantiation; ingesting per-venue Federated Stack Orchestrator master attestation quotes from two or more regulated prediction market exchanges, each comprising a hardware-attestation quote chained to its originating hardware-vendor attestation service; cryptographically validating each per-venue FSO master attestation quote; computing a cross-exchange linkage graph and fused probability estimates under committed rules; binding the validated attestation quotes into a composite attestation chain; enforcing cross-exchange dependency constraints against a committed cross-exchange constraint rule set sealed to the hardware identity of the hardware trusted execution environment, wherein no per-venue attested output record is eligible for inclusion in the composite attestation chain unless all cross-exchange dependency constraints applicable to that output record are satisfied, producing an attested cross-venue consistency-result record; and producing a platform-level master hardware-attestation quote cryptographically signed by the hardware-rooted attestation key and binding the composite attestation chain, the consistency-result record, the cross-exchange linkage graph commitment, the fused probability record, the committed constraint rule-set version, and a consolidated output record to the hardware measurement register, independently verifiable against a hardware-vendor attestation service without participation of, or reliance on representations by, any exchange operator, wherein any modification of any constituent per-venue attested output record, of the composite attestation chain, of the linkage graph commitment, of the fused probability record, or of the consolidated output record invalidates verification of the platform-level master hardware-attestation quote.

4. The platform of claim 1, wherein the hardware trusted execution environment comprises at least one of Intel Software Guard Extensions, Intel Trust Domain Extensions, AMD Secure Encrypted Virtualization with Secure Nested Paging, ARM Confidential Compute Architecture, IBM Secure Execution for Linux, or any equivalent or successor confidential computing architecture providing hardware-rooted measurement, isolation, and remote attestation.

5. The platform of claim 1, wherein the probability fusion module computes each fused probability estimate as an inverse-variance-weighted combination of the per-venue VPCS-attested probability outputs for a cross-listed event contract, weighting each per-venue output by a credibility weight reflecting that venue's historical calibration performance, and binds the committed fusion rule version and the committed uncertainty parameters into the fused probability record, the probability fusion being a function performed by the platform and not by any single participating exchange.

6. The platform of claim 1, further comprising a tamper-evident master ledger organized as a Merkle accumulator whose root is periodically committed to an external public commitment channel comprising at least one of a public blockchain, a regulator-operated commitment endpoint, and a consortium-operated commitment channel.

7. The platform of claim 1, wherein the cross-exchange consistency engine further enforces cross-venue jurisdictional consistency for participants linked by the cross-exchange linkage graph, such that a linked participant is not simultaneously classified as eligible at one venue and ineligible at another absent committed jurisdictional-variation rules.

8. The platform of claim 1, wherein the master consolidation attestation module is further configured to produce an attested cross-venue inconsistency record upon identification of one or more violations, identifying the violated constraint, the exchanges and participants involved, the attested values in dispute, and the committed cross-exchange constraint rule-set version, exported as a first-class verifiable regulatory output.

9. The platform of claim 1, further comprising a unified multi-exchange export module executing within the hardware trusted execution environment and configured to produce composite cross-venue regulatory reporting records drawing upon the attested outputs of the participating exchanges, accompanied by a hardware-attestation quote binding each composite report to the platform-level master hardware-attestation quote.

10. The platform of claim 1, further comprising a differential-privacy module configured to apply Laplace or Gaussian noise with committed epsilon and delta parameters to aggregate multi-venue outputs, and a secure multi-party computation facility with hardware-TEE-anchored per-venue FSO instances for cross-venue federation without disclosure of per-venue plaintext.

11. The platform of claim 1, wherein the platform operates as an apex consolidation layer over a plurality of per-venue FSO instances, each per-venue FSO instance itself orchestrating the Oracle Resolution, HATIS, VPCS, and RCW companion applications, the platform and all per-venue instances sharing a common root of trust through federated hardware attestation, and wherein the platform claims neither the single-venue orchestration performed by any per-venue FSO instance nor the companion functions orchestrated thereby.

12. The platform of claim 1, wherein the cross-exchange linkage engine resolves participant identities across exchanges from cryptographically committed identity representations and produces a linkage-graph commitment bound into the platform-level master hardware-attestation quote, such that cross-venue insider-risk propagation is performed over linked participants without disclosure of plaintext participant identities outside the hardware trusted execution environment.

13. The method of claim 2, wherein the cross-exchange consistency verification further enforces cross-venue jurisdictional consistency for participants linked by the cross-exchange linkage graph, and produces an enumerated violations record upon identification of any violation.

14. The method of claim 2, further comprising committing the platform-level master hardware-attestation quote to a tamper-evident master ledger organized as a Merkle accumulator whose root is periodically published to an external public commitment channel, and enabling a relying party to verify the temporal integrity of a past platform-level master quote through a Merkle inclusion proof.

15. The method of claim 2, further comprising generating and exporting, together with the platform-level master hardware-attestation quote, a zero-knowledge proof attesting that the consolidated output record was produced by the committed consolidation code base under the committed cross-exchange constraint rule set on the committed per-venue attested inputs, without disclosing per-participant data.

16. The method of claim 2, further comprising generating composite cross-venue regulatory reporting records configured to be usable in systems designed to support compliance with applicable regulatory reporting requirements, and producing a hardware-attestation quote binding each composite report to the platform-level master hardware-attestation quote.

17. The method of claim 2, wherein the platform-level master hardware-attestation quote and the attested cross-venue inconsistency record are each formatted such that a relying party comprising a prudential regulator or institutional counterparty verifies the platform-level master hardware-attestation quote against a hardware-vendor attestation service of the platform and, through the composite attestation chain, against the hardware-vendor attestation services of each participating exchange, thereby confirming that the consolidated output was produced by the measured consolidation code base on the attested per-venue inputs without participation of, or reliance on representations by, any exchange operator and without the relying party instantiating a hardware trusted execution environment at the relying party's infrastructure.

18. The non-transitory computer-readable medium of claim 3, wherein the platform-level master hardware-attestation quote comprises: (a) the contents of the hardware measurement register; (b) a hardware-vendor-signed chain-of-trust certificate of the platform; (c) a composite attestation chain root; (d) per-venue quote references including exchange identifier, quote hash, per-venue vendor attestation reference, per-venue rule-set version, and timestamp; (e) the committed cross-exchange constraint rule-set version; (f) the consistency-result record; (g) the cross-exchange linkage graph commitment; (h) the fused probability record including committed fusion rule version and uncertainty parameters; (i) consolidated output digests; and (j) a signature produced using the hardware-rooted attestation key.

19. The non-transitory computer-readable medium of claim 3, wherein the operations further comprise providing the consolidated output record and the platform-level master hardware-attestation quote to an institutional supervisor system that integrates the consolidated output into a prudential supervisory or capital-determination workflow, the institutional supervisor system relying upon the independently verifiable platform-level master hardware-attestation quote to evidence the integrity of the multi-exchange consolidated output without reliance on any exchange operator.

20. The non-transitory computer-readable medium of claim 3, wherein the operations further comprise dynamic reconfiguration of participating exchanges based on attested outputs, including suspension or degradation of the platform-level master hardware-attestation quote upon detection of a per-venue FSO unavailability or attestation failure, wherein the platform-level master hardware-attestation quote cannot be reproduced outside the hardware trusted execution environment without invalidating the quote and any modification to a per-venue companion output outside the platform invalidates the platform-level master hardware-attestation quote.
